(19) United States
(12) Patent Application Publication
(10) Pub. No.: US 2008/0282245 A1
(43) Pub. Date: Nov. 13, 2008

(54) Media Operational Queue Management in Storage Systems

(75) Inventors: Robert A. Kubo, Tucson, AZ (US); Karl A. Nielsen, Tucson, AZ (US); Jeremy M. Pinson, Tucson, AZ (US)

Correspondence Address: INGRASSIA FISHER & LORENZ, P.C. (IBM), 7010 E. COCHISE ROAD, SCOTTSDALE, AZ, 85253, US

(73) Assignee: INTERNATIONAL BUSINESS MACHINES CORPORATION, Armonk, NY (US)

(21) Appl. No.: 11/745,956

(22) Filed: May 8, 2007

(51) Int. Cl. G06F 9/46

(52) U.S. Cl. 718/101

(57) ABSTRACT

A method for media operational queue management in disk storage systems evaluates a plurality of pending storage operations requiring a destage storage operation. A first set of the plurality of pending storage operations is organized in a first array queue grouping (AQG). The AQG is structured such that all of the storage operations are completed within a predefined latency period. A computer-implemented method manages a plurality of pending storage operations in a disk storage system. A pending operation queue is examined to determine a plurality of read and write operations for a first array. A first set of the plurality of read and write operations is grouped into a first array queue grouping (AQG). The first set of the plurality of read and write operations is sent to a redundant array of independent disks (RAID) controller adapter for processing.

### BACKGROUND OF THE INVENTION

1. Field of the Invention

The present invention relates in general to computers, and more particularly to a system and method of media operational queue management in disk storage systems.

2. Description of the Prior Art

Hard disk drives provide the persistent magnetic media on which much of the world's electronic data are stored. One of the primary rationales for storing data on hard disk drives is their characteristic of direct access to storage devices that allow efficient access to random locations within the storage device as compared to other storage media such as sequential access devices like tape media and drives. Hard disk drives are more efficient in accessing data due in part to their mechanical construction and the geometry that is employed to allow the media platters and read/write heads to very quickly be repositioned to disparate locations of the media storage. Most modern devices have multiple platters, mechanical positioning arms and read/write heads.

The optimization of hard disk drive performance for both read and write operations has been the subject of many past studies and published works. Most of these studies include reference to disk scheduling, which refers to the development and implementation of algorithms that factor in variables such as current read/write head position, the head distance travel required to a target location, order of command receipt, and others. One of the observed behaviors of hard disk drive scheduling algorithms is that operations are frequently re-ordered by the hard disk drive, which leads to out-of-order execution of operations that are sent to the hard disk drive.

In some cases, the impact of a hard disk drive scheduling algorithm's re-ordering of operations is increased latency for an operation that happens to require that the hard disk drive seek out of an area that has many operations outstanding in the operation queue. In applications that have a dependency on an operation's completion prior to continuance, one such application is a RAID controller. RAID controllers effectively link multiple hard disk drives logically into a combined address/storage entity with (RAID 1, 3, 5, 6, 10, 51, etc . . . ) or without redundancy (RAID 0). Due to the characteristics of and interdependencies between devices of a RAID array for some operations, the latency of an operation of a single device can retard the performance of the entire array.

### SUMMARY OF THE INVENTION

What is needed is a method to mitigate the impact of the disk scheduling algorithms to provide a deterministic method of ensuring that an operation sent to a hard disk drive is executed within a given response window and not reprioritized outside the desired response window by the disk scheduling algorithm. The method should make use of existing storage devices and network fabrics to provide an efficient, cost-effective solution.

Accordingly, in one embodiment, the present invention is a method for media operational queue management in disk storage systems, comprising evaluating a plurality of pending storage operations requiring a destage storage operation, and organizing a first set of the plurality of pending storage operations in a first array queue grouping (AQG), wherein the AQG is structured such that all of the storage operations are completed within a predefined latency period.

In another embodiment, the present invention is a computer-implemented method for managing a plurality of pending storage operations in a disk storage system, comprising examining a pending operation queue to determine a plurality of read and write operations for a first array, grouping a first set of the plurality of read and write operations into a first array queue grouping (AQG), and sending the first set of the plurality of read and write operations to a redundant array of independent disks (RAID) controller adapter for processing.

In still another embodiment, the present invention is an article of manufacture including code for media operational queue management in disk storage systems, wherein the code is capable of causing operations to be performed comprising evaluating a plurality of pending storage operations requiring a destage storage operation, and organizing a first set of the plurality of pending storage operations in a first array queue grouping (AQG), wherein the AQG is structured such that all of the storage operations are completed within a predefined latency period.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict embodiments of the invention and are not therefore to be considered to be limiting of its scope, the invention will be described and explained with additional specificity and detail through the use of the accompanying drawings, in which:

FIG. 1 illustrates an example of disk drive internal components;

FIG. 2 illustrates an example of a computer system including a disk storage system in which various aspects of the present invention can be implemented; and

FIG. 3 illustrates an example of a method of operation in which various aspects of the present invention can be implemented.

### DETAILED DESCRIPTION OF THE PREFERRED EMBODIMENTS OF THE INVENTION

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, a digital-video disk, a magnetic tape, a Bernoulli drive, a magnetic disk, a punch card, a flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

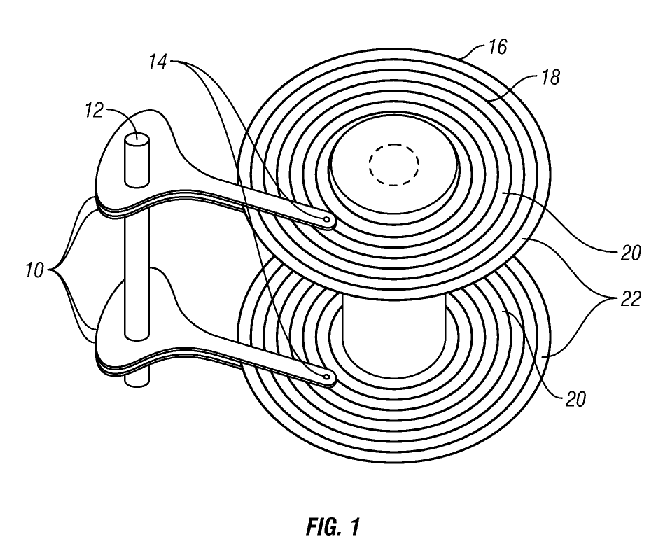

FIG. 1 depicts disk drive internal components, such as arms 10 attached to an actuator spindle 12 that rotates to move the arms 10. Read/write heads 14 located on the end of the arms 10 read and write information from the disk platters 16. Each platter contains such subcomponents as sectors 18, cylinders 20, and servo identifiers 22. A motor (not shown) rotates the platter 16.

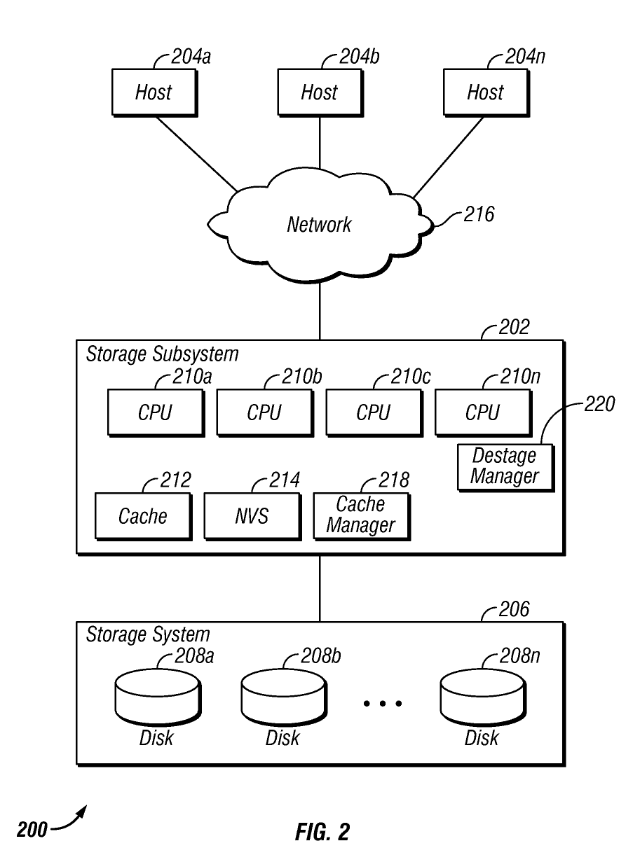

Turning to FIG. 2, an example of a storage subsystem computing environment 200 in which aspects of the present invention can be implemented is depicted. A storage subsystem 202 receives I/O requests from hosts 204a, 204b, . . . 204n directed to tracks in a storage system 206, which comprises one or more hard disk drives 208a, 208b, . . . 208n. The storage system 206 and disk drives 208a, 208b, . . . 208n may be configured as a DASD, one or more RAID ranks, etc. The storage subsystem 202 further includes one or more central processing units (CPUs) 210a, 210b, 210c, . . . 210n, a cache module 212 comprising a volatile memory to store tracks, and a non-volatile storage unit (NVS) 214 in which certain dirty (corrupted) or modified tracks in cache are buffered. The hosts 204a, 204b, . . . 204n communicate I/O requests to the storage subsystem 202 via a network 216, which may comprise any network known in the art, such as a Storage Area Network (SAN), Local Area Network (LAN), Wide Area Network (WAN), the Internet, an Intranet, etc. The cache 212 may be implemented in one or more volatile memory device modules and the NVS 214 in one or more high-speed non-volatile storage devices, such as a battery-backed-up volatile memory. A cache manager module 218 comprises either a hardware component or process executed by one of the CPUs 210a, 210b, . . . 210n that manages the cache 212. A destage manager module 220 comprises a software or hardware component that manages destage operations. Cache manager 218 and/or destage manager 220 can operate using hardware and software as described. Additionally, however, cache manager 218 and/or destage manager 220 can operate using a combination of various hardware and software that operates and executes on a storage subsystem 202 to perform processes herein described.

The present invention presents a method to coalesce and accumulate operations into groupings that are based on thresholds at the host or adapter level and burst them in groups to the hard disk drives (HDDs, e.g., disks 208a, 208b, . . . 208n) in a controlled manner that guarantees, for a given grouping, independent of order of execution of operations at the disk level, nominal completion of all operations within a given performance envelope. The host system or RAID controller software evaluates the pending operations that require destage storage operations and gathers on a per rank/array basis the operations into a stage/destage grouping, referred to as an “array queue grouping” (AQG). The AQG content is structured such that the number of operations is optimized to guarantee a response time from the hard disk devices (i.e. the number of operations is limited such that, nominally independent of the hard disk devices reordering of the operations, all rank queue grouping operations will be completed within a given latency). Only one AQG per RANK/ARRAY is active at any particular time.

An array queue grouping can be constructed by examining the pending operation queue to determine on an array basis the number of read and write operations for a particular array (which by extension translates to operations for a logical grouping of hard disk devices). The pending operations for an array are grouped into an AQG and sent to the RAID controller/adapter in a burst of transactions for processing. By limiting the number of AQGs that are sent to the adapter to one, it is guaranteed that, independent of the process of re-ordering of operations by disk scheduling algorithms, all operations within the AQG will be nominally executed by the hard disk drive within an expected latency.

In one embodiment, a RAID controller adapter module (e.g., incorporating one or more CPUs 210n, see FIG. 2) can be configured to provide similar functionality that can manage the AQGs either on an array or a hard disk level. In one embodiment, the RAID adapter can provide an additional layer of operation queue management at a hard disk level by managing the pending operations to individual hard disk drives. In another embodiment, the adapter can manage the entire AQG concept.

The AQG content is managed to provide quality of service performance attributes, which enables some storage user workloads that are dependent upon storage response times to remain viable at an optimum level.

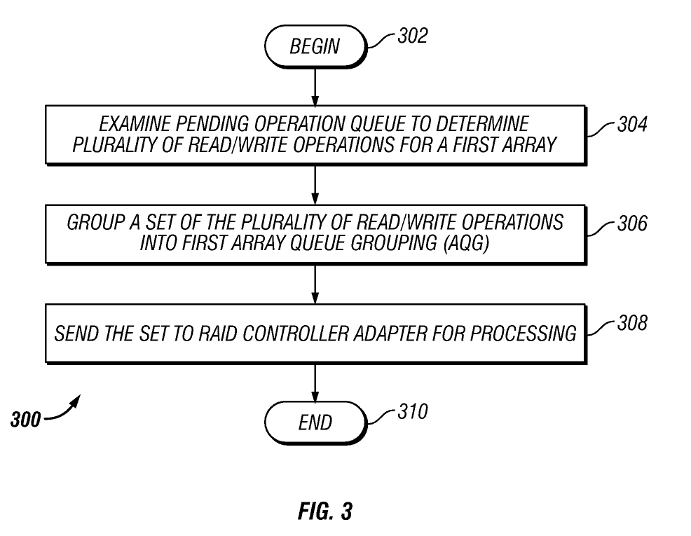

Turning to FIG. 3, an examplary method of operation 300, in which various aspects of the present invention can be implemented, is presented. Method 300 begins (step 302) with the examination of the storage system's pending operation queue to determine a plurality of read/write operations attributable to a first selected array in the RAID array (step 304).

From the plurality of read/write operations, the method 300 then groups or organizes a set of read/write operations into a first array queue grouping (AQG) (step 306). Again, the AQG can be structured such that the number of operations is optimized to guarantee a response time from the hard disk devices. A predefined latency period or response time can be ensured by limiting the number of operations in the set so that each of the plurality of operations is completed within the latency period, independent of any reordering of the operations by the hard disk devices.

Here again, an array queue grouping can be constructed by examining the pending operation queue to determine on an array basis the number of read and write operations for a particular array (which by extension translates to operations for a logical grouping of hard disk devices). The pending operations for an array are grouped into an AQG and sent to the RAID controller/adapter in a burst of transactions for processing (step 308). Method 300 then ends (step 310).

Software and/or hardware to implement the method 300, or other functions previously described, such as the described selection of a set from the plurality of read/write operations, can be created using tools currently known in the art. The implementation of the described system and method involves no significant additional expenditure of resources or additional hardware than what is already in use in standard computing environments utilizing RAID storage topologies, which makes the implementation cost-effective.

Implementing and utilizing the examples of systems and methods as described can provide a simple, effective method of managing storage media operations as described, and serves to maximize the performance of the storage system. While one or more embodiments of the present invention have been illustrated in detail, the skilled artisan will appreciate that modifications and adaptations to those embodiments may be made without departing from the scope of the present invention as set forth in the following claims.

What is claimed is:

1. A method for media operational queue management in disk storage systems, comprising:
evaluating a plurality of pending storage operations requiring a destage storage operation; and
organizing a first set of the plurality of pending storage operations in a first array queue grouping (AQG), wherein the AQG is structured such that all of the storage operations are completed within a predefined latency period.

2. The method of claim 1, further including organizing a second set of the plurality pending storage operations in a second array queue grouping (AQG).

3. The method of claim 2, wherein only the first array queue grouping (AQG) or the second array queue grouping (AQG) is active at one period of time.

4. The method of claim 1, wherein evaluating a plurality of pending storage operations is performed by a host system or a redundant array of independent disks (RAID) controller software operational on the disk storage system.

5. The method of claim 1, wherein the first array queue grouping (AQG) is organized according to an array ranking.

6. The method of claim 1, wherein organizing the first set of the plurality of pending storage operations is performed by a redundant array of independent disks (RAID) controller adapter.

7. The method of claim 1, wherein the predefined latency period is determined by examining a plurality of storage user workloads dependent upon storage response times.

8. A computer-implemented method for managing a plurality of pending storage operations in a disk storage system, comprising:
examining a pending operation queue to determine a plurality of read and write operations for a first array;
grouping a first set of the plurality of read and write operations into a first array queue grouping (AQG);
sending the first set of the plurality of read and write operations to a redundant array of independent disks (RAID) controller adapter for processing.

9. The method of claim 8, further including grouping a second set of the plurality of read and write operations into a second array queue grouping (AQG).

10. The method of claim 9, wherein only the first array queue grouping (AQG) or the second array queue grouping (AQG) is active at one period of time.

11. The method of claim 8, wherein grouping the first set of the plurality of read and write operations into the first array queue grouping (AQG) is performed by a host system or a redundant array of independent disks (RAID) controller software operational on the disk storage system.

12. The method of claim 8, wherein the first array queue grouping (AQG) is organized according to an array ranking including the first array.

13. The method of claim 8, wherein organizing the first set of the plurality of pending storage operations is performed by a redundant array of independent disks (RAID) controller adapter.

14. The method of claim 8, wherein the first array queue grouping (AQG) is further organized such that all of the read and write operations are completed within a predefined latency period

15. An article of manufacture including code for media operational queue management in disk storage systems, wherein the code is capable of causing operations to be performed comprising:
evaluating a plurality of pending storage operations requiring a destage storage operation; and
organizing a first set of the plurality of pending storage operations in a first array queue grouping (AQG), wherein the AQG is structured such that all of the storage operations are completed within a predefined latency period.

16. The article of manufacture of claim 15, further including code for organizing a second set of the plurality pending storage operations in a second array queue grouping (AQG).

17. The article of manufacture of claim 16, wherein only the first array queue grouping (AQG) or the second array queue grouping (AQG) is active at one period of time.

18. The article of manufacture of claim 15, wherein evaluating a plurality of pending storage operations is performed by a host system or a redundant array of independent disks (RAID) controller software operational on the disk storage system.

19. The article of manufacture of claim 15, wherein organizing the first set of the plurality of pending storage operations is performed by a redundant array of independent disks (RAID) controller adapter.
